(19) United States
(12) Patent Application Publication
(10) Pub. No.: US 2020/0329710 A1
(43) Pub. Date: Oct. 22, 2020

(54) Materials and Methods for Treating Bacterial Infections in Plants

(71) Applicant: Locus Agriculture IP Company, LLC, Solon, OH (US)

(72) Inventors: Sean FARMER, North Miami Beach, FL (US); Ken ALIBEK, Solon, OH (US); Maja MILOVANOVIC, North Royalton, OH (US); Samal IBRAGIMOVA, Solon, OH (US)

(21) Appl. No.: 16/770,868

(22) PCT Filed: Jan. 15, 2019
(86) PCT No.: PCT/US2019/013627

§ 371 Date: Jun. 8, 2020

Related U.S. Application Data
(60) Provisional application No. 62/617,422, filed on Jan. 15, 2018.

(51) Int. Cl. A01N 47/44; A01N 25/30; A01N 63/32; A01N 63/22; A01N 63/27; A01N 63/20; A01N 63/50; A01N 25/24; A01N 43/22; A01N 45/00

(52) U.S. Cl. CPC A01N 47/44; A01N 25/30; A01N 63/32; A01N 63/22; A01N 45/00; A01N 63/20; A01N 63/50; A01N 25/24; A01N 43/22; A01N 63/27

(57) ABSTRACT

Compositions and methods are provided for enhancing plant immunity, health, growth and yields. In particular, the subject invention relates to treatment and/or prevention of plant pathogenic bacterial infections using microbes and/or their growth by-products. Specifically, the subject invention can be used to treat and/or prevent citrus greening disease and citrus canker disease. In certain embodiments, the growth by-products are biosurfactants and/or enzymes.

### CROSS-REFERENCE TO RELATED APPLICATION

This application claims the benefit of U.S. provisional application Ser. No. 62/617,422, filed Jan. 15, 2018, which is incorporated herein by reference in its entirety.

### BACKGROUND OF THE INVENTION

In the agriculture industry, certain common issues continue to hinder the ability of farmers to maximize production yields while keeping costs low. These include, but are not limited to, infections and infestations caused by bacteria, fungi, and other pests and pathogens; the high costs of chemical fertilizers and herbicides, including their environmental and health impacts; and the difficulty for plants to efficiently absorb nutrients and water from different types of soil.

In citrus production, widespread infection of citrus plants by pathogens such as citrus greening disease and citrus canker disease has led to significant hardships for citrus growers. As much as entire crops have been lost to these bacterial infections, leading to a decline in the production, and increase in price, of citrus products worldwide.

Citrus greening disease, which is also known is Huanglongbing (HLB) or yellow dragon disease, is an incurable infection caused by the Gram-negative bacterium Candidatus Liberibacter asiaticus. This disease has caused devastation for millions of acres of citrus crops throughout the United States and other parts of the world. The disease is spread by a disease-infected insect, the Asian citrus psyllid, and has put the future of America's citrus at risk. Infected trees produce fruits that are green, misshapen and bitter, which makes them unsuitable for sale as fresh fruit or for juice. Most infected trees die within a few years, as the disease is incurable.

Citrus canker disease is caused by the Gram-negative bacterium Xanthomonas axonopodis. An infection causes lesions on leaves, stems and fruit of citrus trees. This disease is not harmful to humans, but can have significant effects on the vitality and production capacity of entire citrus groves. The disease causes leaves and fruit to drop prematurely, and while the fruit is safe to eat, it generally will not be sold because of its unappealing appearance.

Growers have relied heavily on the use of synthetic chemicals and chemical fertilizers for boosting crop yields and protecting crops from drought and disease. However, when overused or improperly applied, these substances can run off into surface water, leach into groundwater, and evaporate into the air. As sources of air and water pollution, responsible use of these substances is an ecological and commercial imperative. Even when properly used, the over-dependence and long-term use of certain chemical fertilizers, pesticides and antibiotics deleteriously alters soil ecosystems, reduces stress tolerance, increases pest resistance, and impedes plant growth and vitality.

Additionally, antibiotics such as oxytetracyc line and streptomycin have been approved for use on citrus crops in, e.g., Florida, which has been hit particularly hard by the effects of citrus greening disease. These antibiotics can treat the disease, i.e., reduce symptoms, but they are not a cure. They have already been used in the country's apple and pear farms, but the quantity that is needed when dealing with the much larger Florida orange crop is much higher than that of other crops. The use of antibiotics in such large quantities is worrisome to some who believe these substances will infiltrate into fruit products grown for consumption and/or contribute to antibiotic resistance.

To address the global needs for sustainable methods of producing food and consumable products, microbes such as bacteria, yeast and fungi, as well as their byproducts, are becoming increasingly useful in many settings, including agriculture and horticulture, animal husbandry, forestry, and remediation of soils, waters and other natural resources. For example, farmers are embracing the use of biological agents such as live microbes, bio-products derived from these microbes, and combinations thereof, as biopesticides and biofertilizers. In particular, biosurfactants produced by microorganisms are especially useful agents in agricultural applications.

These biological agents have important advantages over other conventional pesticides and fertilizers. The advantages include: 1) they are less harmful compared to conventional chemicals; 2) they are more efficient and specific; 3) they often biodegrade quickly, leading to less environmental pollution. The economic costs and the adverse health and environmental impacts of current methods of crop production continue to burden the sustainability and efforts of producing food and other crop-based consumer products.

Thus, there is a continuing need for improved, non-toxic and environmentally-friendly methods of enhancing crop production at a low cost. In particular, there is a need for products to combat certain pathogenic and widespread bacterial infections in citrus plants, such as citrus greening and citrus canker, all without compromising the environment in which they are used or the living beings who produce and consume them.

### BRIEF SUMMARY OF THE INVENTION

The subject invention provides microbes, as well as by-products of their growth, such as biosurfactants. The subject invention also provides methods of using these microbes and their by-products, as well as methods and systems for producing them. Advantageously, the microbe-based products and methods of the subject invention are environmentally-friendly and cost-effective.

In preferred embodiments, the subject invention provides pesticidal compositions and methods of their use. Advantageously, the pesticidal compositions can enhance the immunity, health, growth and overall yields of crop plants by, for example, preventing and/or treating a bacterial infection.

Specifically, the subject invention provides for treatment and/or prevention of bacterial pathogens that infect citrus crops, such as, e.g., Candidatus Liberibacter asiaticus (citrus greening disease) and Xanthomonas axonopodis (citrus canker disease). Advantageously, the subject invention significantly reduces the concentration of antibiotics required for such treatment.

In one embodiment, the subject invention provides pesticidal composition comprising one or more beneficial microorganisms and/or microbial growth by-products. Also provided are methods of cultivating the pesticidal composition. Preferably, the pesticidal composition is formulated to be suitable for application to the foliage and/or fruit of citrus plants.

The composition may comprise, for example, the one or more beneficial microorganisms along with any products of fermentation. In some embodiments, the by-products include microbial growth by-products, including, for example, biosurfactants, enzymes and/or other metabolites.

In one embodiment, the pesticidal composition controls plant-pathogenic bacteria. In one embodiment, the pesticidal composition controls pests that might act as vectors or carriers for pathogenic bacteria, such as insects.

In certain embodiments, the subject invention utilizes a biochemical-producing microorganism that is tolerant to antibiotics. In one embodiment, the beneficial microorganism is a yeast, such as, for example, Starmerella bombicola, Wickerhamomyces anomalus, Pseudozyma aphidis or Pichia spp.

In some embodiments, the beneficial microorganism is a non-plant-pathogenic bacteria, such as, for example, Bacillus amyloliquefaciens, Pseudomonas chlororaphis, or Rhodococcus erythropolis.

These microbes produce growth by-products that are active against, for example, bacterial, insect and/or nematode pests.

In some embodiments, the growth by-product of the subject composition is a biosurfactant. Biosurfactants according to the subject invention include, for example, low-molecular-weight glycolipids, cellobiose lipids, lipopeptides, flavolipids, phospholipids, and high-molecular-weight polymers such as lipoproteins, lipopolysaccharide-protein complexes, and/or polysaccharide-protein-fatty acid complexes.

In one embodiment, the biosurfactant is a glycolipid, such as, for example, sophorolipids (SLP), trehalose lipids or mannosylerythritol lipids (MEL). In one embodiment, the biosurfactant is a lipopeptide such as surfactin, lichenysin or athrofactin.

In some embodiments, the growth by-product is an enzyme, such as an amylase, a hydrolytic enzyme, and/or a protease. In exemplary embodiments, the enzyme can be chitinase or beta-glucanase.

In one embodiment, the composition comprises the one or more microbial growth by-products separated from the microorganism that produced them. The growth by-products can be in a purified or unpurified form.

In certain preferred embodiments, the beneficial microorganism is cultivated in a medium comprising low concentrations of antibiotics (e.g., about 200 ppm or less). Accordingly, in some embodiments, the microbe-based product can comprise residual amounts of antibiotic substances, thus increasing the pesticidal capabilities of the composition.

In one embodiment, the composition further comprises one or more adherent substances, which allow the composition to remain on the surfaces of plant vegetation for extended periods of time. Adherent substances can include charged polymers or polysaccharides, such as, for example, xanthan gum, guar gum, levan, xylinan, welan gum, gellan gum, curdlan, and/or pullulan.

The composition may further comprise other acceptable active or inactive components, such as, for example, salts, solvents, additional purified biosurfactants and/or enzymes, and/or chelating agents.

In certain embodiments, the compositions of the subject invention have advantages over, for example, purified microbial metabolites alone. These advantages can include, for example, high concentrations of mannoprotein as a part of a yeast cell wall's outer surface, the presence of a variety of microbial growth by-products in the culture, such as biosurfactants, enzymes, solvents and/or other metabolites, and the presence of residual antibiotic substances in the culture.

In certain embodiments, methods are provided for cultivating the pesticidal composition of the subject invention, wherein a beneficial microorganism is cultivated under conditions favorable for growth and production of one or more pesticidal growth by-products. In some embodiments, the beneficial microorganism is cultivated in a medium comprising low concentrations of antibiotics such as, e.g., streptomycin, erythromycin, and/or oxytetracycline. The presence of antibiotics in the culture can, in some embodiments, induce the microorganism to produce the growth by-products that are active against, for example, bacterial pests.

Optionally, if a microbe-free composition is desired, the method can further comprise extracting and purifying a growth by-product from the fermentation medium in which it was produced, using methods known in the art.

The pesticidal composition of the subject invention can be obtained through cultivation processes ranging from small to large scale. These cultivation processes include, but are not limited to, submerged cultivation/fermentation, solid state fermentation (SSF), fluidized bed fermentation and combinations thereof.

In some embodiments, methods are provided for enhancing plant immunity, health, growth and/or yields by treating and/or preventing a bacterial infection in the plant, wherein a pesticidal composition of the subject invention is applied to the plant and/or its surrounding environment. In preferred embodiments, the plant is a citrus plant.

In a specific embodiment, the pesticidal composition is contacted with the foliage and/or fruit of the plant. The pesticidal composition can also be contacted with the soil in which the plant grows, the seeds of the plant prior to, or at the time of, planting, or with any other part of the plant and/or its surrounding environment.

The pesticidal composition can be applied either alone or in combination with other compounds for efficiently enhancing plant immunity, health and growth. For example, in some embodiments, the composition further comprises, and/or is applied alongside, additional components, such as herbicides, fertilizers, pesticides, antibiotics and/or soil amendments. Other additional elements can include, for example, nutrients such as magnesium, phosphate, nitrogen, potassium, selenium, calcium, sulfur, iron, copper, and zinc. The exact materials and the quantities thereof can be determined by one skilled in the art of cultivating plants.

The microbe-based products of the subject invention can be used in a variety of unique settings because of, for example, the ability to efficiently deliver: a fresh mixture of cells, spores and/or mycelia with active fermentation by-products and microbial metabolites; compositions with a high density of cells, including vegetative cells, spores and/or mycelia; microbe-based products on short-order; and microbe-based products in remote locations.

Advantageously, the present invention can serve as a “green” substitute for other methods that release large quantities of inorganic compounds into the environment. Additionally, the compositions and methods utilize components that are biodegradable and toxicologically safe.

### DETAILED DESCRIPTION OF THE INVENTION

The subject invention provides microbes, as well as by-products of their growth, such as biosurfactants. The subject invention also provides methods of using these microbes and their by-products, as well as methods and systems for producing them. Advantageously, the microbe-based products and methods of the subject invention are environmentally-friendly, non-toxic and cost-effective.

In preferred embodiments, the subject invention provides pesticidal compositions and methods of their use. Advantageously, the pesticidal compositions can enhance the health, growth and overall yields of crop plants by, for example, preventing and/or treating a bacterial infection.

Specifically, the subject invention provides for treatment and/or prevention of bacterial pathogens that infect citrus crops, such as, e.g., Candidatus Liberibacter asiaticus (citrus greening disease) and Xanthoinonas axonopodis (citrus canker disease). Advantageously, the subject invention significantly reduces the concentration of antibiotics required for such treatment.

In one embodiment, the subject invention provides pesticide compositions comprising one or more microorganisms and/or microbial growth by-products. Also provided are methods of cultivating the composition. Preferably, the microbe-based product is formulated to be suitable for application to the foliage and/or fruit of citrus plants.

### Selected Definitions

As used herein, reference to a “microbe-based composition” means a composition that comprises components that were produced as the result of the growth of microorganisms or other cell cultures (e.g., the pesticidal composition of the subject invention). Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In some embodiments, the microbes are present, with medium in which they were grown, in the microbe-based composition. The cells may be present at, for example, a concentration of 1×10⁴, 1×10⁵, 1×10⁶, 1×10⁷, 1×10⁸, 1×10⁹, 1×10¹⁰, 1×10¹¹, 1×10¹², 1×10¹³ or more CFU/milliliter of the composition. In some embodiments, the composition comprises growth by-products that have been separated from the microbes that produced them.

The subject invention further provides “microbe-based products,” which are products that are to be applied in practice to achieve a desired result. The microbe-based product can be simply the microbe-based composition harvested from the microbe cultivation process. Alternatively, the microbe-based product may have components removed, or may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “harvested” refers to removing some or all of the microbe-based composition from a growth vessel.

As used herein, a “biofilm” is a complex aggregate of microorganisms, wherein the cells adhere to each other and produce extracellular substances that encase the cells. Biofilms can also adhere to surfaces. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An “isolated” strain in the context of a microbial strain means that the strain is removed from the environment in which it exists in nature. Thus, the isolated strain may exist as, for example, a biologically pure culture, or as spores (or other forms of the strain) in association with a carrier.

As used here in, a “biologically pure culture” is one that has been isolated from materials with which it is associated in nature. In a preferred embodiment, the culture has been isolated from all other living cells. In further preferred embodiments, the biologically pure culture has advantages characteristics compared to a culture of the same microbe as it exists in nature. The advantageous characteristics can be, for example, enhanced production of one or more by-products of their growth.

In certain embodiments, purified compounds are at least 60% by weight (dry weight) the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, biopolymers, enzymes, acids, solvents, alcohols, proteins, vitamins, minerals, microelements, amino acids, and biosurfactants.

As used herein, “modulate” is interchangeable with alter (e.g., increase or decrease). Such alterations are detected by standard art known methods such as those described herein.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” refers to a negative alteration of at least 1%, 5%, 10%, 25%, 50%, 75%, or 100%.

As used herein, “reference” refers to a standard or control condition.

As used herein, “surfactant” refers to a compound that lowers the surface tension (or interfacial tension) between two liquids or between a liquid and a solid. Surfactants act as detergents, wetting agents, emulsifiers, foaming agents, and dispersants. A “biosurfactant” is a surfactant produced by a living organism.

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture is the care, monitoring and maintenance of soil.

As used herein, “enhancing” means improving or increasing. For example, enhanced plant health means improving the plant's ability grow and thrive, and the plant's ability to survive disease, droughts and/or overwatering. Enhanced plant growth means increasing the size and/or mass of a plant, or improving the ability of the plant to reach a desired size and/or mass. Enhanced yields mean improving the end products produced by the plants in a crop, for example, by increasing the number of fruits per plant, increasing the size of the fruits, and/or improving the quality of the fruits (e.g., taste, texture).

As used herein, “immunity” in reference to a plant means the plant's systemic acquired resistance (SAR). SAR is the plant's ability to recognize triggers, signatures and/or patterns associated with pathogenic exposure and respond accordingly (e.g., through gene induction) to ward off and/or recover from the pathogen.

As used herein, “treatment” in reference to a pest or pathogen means the eradicating, improving, reducing, ameliorating or reversing of a degree, sign or symptom thereof. Treatment can include, but does not require, a complete cure, meaning treatment can also include partial eradication, improvement, reduction, amelioration or reversal.

As used herein, “prevention” means avoiding, delaying, forestalling, or minimizing the onset or progression of an occurrence or situation. Prevention can include, but does not require, absolute or complete prevention, meaning the occurrence or situation may still develop at a later time and/or with a lesser severity than it would without preventative measures. Prevention can include reducing the severity of the onset of an occurrence or situation, and/or inhibiting the progression thereof to one that is more severe.

As used herein, the term “control” used in reference to a pest means killing, disabling, immobilizing, or reducing population numbers of a pest, or otherwise rendering the pest substantially incapable of causing harm.

As used herein, a “pest” is any organism, other than a human, that is destructive, deleterious and/or detrimental to humans or human concerns (e.g., agriculture). Pests may cause and/or carry agents that cause infections, infestations and/or disease. Pests may be single- or multi-cellular organisms, including but not limited to, viruses, fungi, bacteria, parasites, arthropods and/or nematodes.

As used herein, a “soil amendment” or a “soil conditioner” is any compound, material, or combination of compounds or materials that are added into soil to enhance the properties of the soil and/or rhizosphere. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the growth and health of plants by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof. All references cited herein are hereby incorporated by reference in their entirety.

### Compositions

In preferred embodiments, the subject invention provides pesticidal compositions and methods of their use. Advantageously, the pesticidal compositions can enhance the immunity, health, growth and overall yields of crop plants by, for example, preventing and/or treating a bacterial infection.

Specifically, the subject invention provides for treatment and/or prevention of bacterial pathogens that infect citrus crops, such as, e.g., Candidatus Liberibacter asiaticus (citrus greening disease) and Xanthomonas axonopodis (citrus canker disease). Advantageously, the subject invention significantly reduces the concentration of antibiotics required for such treatment.

Advantageously, the microbe-based compositions produced according to the subject invention are non-toxic (i.e., ingestion toxicity is more than 5 g/kg) and can be applied in high concentrations without causing irritation to, for example, skin or the digestive tract. Thus, the subject invention is particularly useful where application of the microbe-based compositions occurs in the presence of living organisms, such as farmers and growers.

In one embodiment, the composition may comprise, for example, the one or more beneficial microorganisms along with any products of fermentation. In some embodiments, the by-products include microbial growth by-products, including, for example, biosurfactants, enzymes and/or other metabolites.

In one embodiment, the pesticidal composition controls plant-pathogenic bacteria. In one embodiment, the pesticidal composition controls pests that might act as vectors or carriers for pathogenic bacteria, such as insects.

In certain embodiments, the subject invention utilizes a biochemical-producing microorganism that is tolerant to antibiotics. In one embodiment, the beneficial microorganism is a yeast, such as, for example, Starmerella bombicola, Wickerhamomyces anomalus, Pseudozyma aphidis or Pichia spp. In some embodiments, the beneficial microorganism is a non-plant-pathogenic bacteria, such as, for example, Bacillus amyloliquefaciens, Pseudomonas chlororaphis, or Rhodococcus erythropolis.

These microbes produce growth by-products that are active against, for example, bacterial, insect and/or nematode pests.

In some embodiments, the growth by-product of the subject composition is a biosurfactant. Biosurfactants are a structurally diverse group of surface-active substances produced by microorganisms. Biosurfactants are biodegradable and can be efficiently produced, according to the subject invention, using selected organisms on renewable substrates. Most biosurfactant-producing organisms produce biosurfactants in response to the presence of a hydrocarbon source (e.g. oils, sugar, glycerol, etc.) in the growing media. Other media components such as concentration of iron can also affect biosurfactant production significantly.

Microbial biosurfactants are produced by a variety of microorganisms such as bacteria, fungi, and yeasts. Exemplary biosurfactant-producing microorganisms include Starmerella spp. (e.g., S. bombicola), Pseudomonas spp. (e.g., P. aeruginosa, P. putida, P. florescens, P. Tragi, P. syringae); Flavobacterium spp.; Bacillus spp. (e.g., B. subtilis, B. amyloliquefaciens, B. pumillus, B. cereus, B. licheniformis); Wickerhamomyces spp. (e.g., W. anomalus), Candida spp. (e.g., C. albicans, C. rugosa, C. tropicalis, C. lipolytica, C. torulopsis); Saccharomyces (e.g., S. cerevisiae); Pseudozyma spp. (e.g., P. aphidis); Rhodococcus spp. (e.g., R. erythropolis); Arthrobacter spp.; Campylobacter spp.; Cornybacterium spp.; Pichia spp. (e.g., P. guilliermondii, P. occidentalis); as well as others.

Biosurfactants are amphiphiles. They consist of two parts: a polar (hydrophilic) moiety and non-polar (hydrophobic) group. Due to their amphiphilic structure, microbial biosurfactants reduce the surface and interfacial tensions between the molecules of liquids, solids, and gases. This dynamic can be used to facilitate plant health, increase yields, manage soil aeration, and responsibly utilize available irrigation water resources.

Additionally, biosurfactants increase the surface area of hydrophobic water-insoluble substances, increase the water bioavailability of such substances. Biosurfactants accumulate at interfaces, thus reducing interfacial tension and leading to the formation of aggregated micellar structures in solution. The ability of biosurfactants to form pores and destabilize biological membranes permits their use as, e.g., antibacterial and antifungal agents.

Furthermore, biosurfactants are biodegradable, have low toxicity, are effective in solubilizing and degrading insoluble compounds in soil and can be economically produced using low-cost renewable resources. They can inhibit microbial adhesion to a variety of surfaces, prevent the formation of biofilms, and can have powerful emulsifying and demulsifying properties. Furthermore, biosurfactants can also be used to obtain wettability and to achieve even distribution of fertilizers, nutrients, and water in the soil.

According to the subject invention, biosurfactants can include, for example, low-molecular-weight glycolipids, cellobiose lipids, lipopeptides, flavolipids, phospholipids, and high-molecular-weight polymers such as lipoproteins, lipopolysaccharide-protein complexes, and/or polysaccharide-protein-fatty acid complexes.

The hydrocarbon chain of a fatty acid acts as the common lipophilic moiety of a biosurfactant molecule, whereas the hydrophilic part is formed by ester or alcohol groups of neutral lipids, by the carboxylate group of fatty acids or amino acids (or peptides), organic acid in the case of flavolipids, or, in the case of glycolipids, by the carbohydrate.

In one embodiment, the biosurfactants according to the subject compositions comprise glycolipids and/or glycolipid-like biosurfactants, such as, for example, rhamnolipids (RLP), sophorolipids (SLP), trehalose lipids or mannosylerythritol lipids (MEL). In one embodiment, the biosurfactants comprise lipopeptides and/or lipopeptide-like biosurfactants, such as, e.g., surfactin, iturin, fengycin, athrofactin, viscosin and/or lichenysin. In one embodiment, the biosurfactants comprise polymeric biosurfactants, such as, for example, emulsan, lipomanan, alasan, and/or liposan.

In certain preferred embodiments, the biosurfactant is a glycolipid selected from sophorolipids (SLP), trehalose lipids and mannosylerythritol lipids (MEL); and/or the biosurfactant is a lipopeptide such as surfactin, lichenysin or athrofactin.

In one exemplary embodiment, the biosurfactant is a sophorolipid. There exist at least eight structurally different sophorolipids. The chemical composition an SLP is formed by a sophorose and a fatty acid or an ester group. Macrolactone and free acid structures are acetylated to various extents at the primary hydroxyl position of the sophorose ring. The main component of a sophorolipid is 17-hydroxyoctadecanoic acid and its corresponding lactone. Additionally, unsaturated C-18 fatty acids of oleic acid may be transferred unchanged into sophorolipids.

In some embodiments, the pesticidal composition can comprise about 10 ppm to about 10,000 ppm of biosurfactant, or about 100 ppm to about 5,000 ppm, or about 200 to about 1,000 ppm, or about 300 ppm to about 800 ppm, or about 500 ppm.

In some embodiments, the composition comprises at least 0.01 g/L to 5.0 g/L, or at least 0.05 g/L to 1.0 g/L, or at least 0.1 g/L to 0.5 g/L of biosurfactant in the final product.

In some embodiments, the growth by-product is an enzyme. Enzymes are typically divided into six classes: oxidoreductases, transferases, hydrolases, lyases, isomerases and ligases. Each class is further divided into subclasses and by action. Specific subclasses of enzymes according to the subject invention include, but are not limited to, proteases, amylases, glycosidases, cellulases, glucosidases, glucanases, galactosidases, mannosidases, sucrases, dextranases, hydrolases, methyltransferases, phosphorylases, dehydrogenases (e.g., glucose dehydrogenase, alcohol dehydrogenase), oxygenases (e.g., alkane oxygenases, methane monooxygenases, dioxygenases), hydroxylases, esterases, lipases, ligninases, mannanases, oxidases, laccases, tyrosinases, cytochrome P450 enzymes, peroxidases (e.g., chloroperoxidase and other haloperoxidasese), and lactases. In exemplary embodiments, the enzyme can be chitinase or beta-glucanase.

In certain embodiments, the pesticidal composition can comprise the fermentation by-products containing a live and/or an inactive culture and/or the microbial metabolites produced by the microorganism and/or any residual nutrients. The product of fermentation may be used directly, with or without extraction or purification. If desired, extraction and purification can be easily achieved using standard extraction and/or purification methods or techniques described in the literature.

In one embodiment, the composition may comprise the medium in which the microbes were grown. The composition may be, for example, at least, by weight, 1%, 5%, 10%, 25%, 50%, 75%, or 100% growth medium. The amount of biomass in the composition, by weight, may be, for example, anywhere from 0% to 100% inclusive of all percentages therebetween.

The microorganisms may be in an active or inactive form, or in the form of vegetative cells, reproductive spores, mycelia, hyphae, conidia or any other form of microbial propagule. The composition may also contain a combination of any of these microbial forms.

In one embodiment, when a combination of strains of microorganism are included in the composition, the different strains of microbe are grown separately and then mixed together to produce the composition.

In one embodiment, the composition does not comprise living microorganisms. In one embodiment, the composition does not comprise microorganisms, whether living or inactive.

In one embodiment, the composition comprises the one or more microbial growth by-products separated from the microorganism that produced them. The growth by-products can be in a purified or unpurified form.

In certain preferred embodiments, the beneficial microorganism is cultivated in a medium comprising low concentrations of antibiotics (e.g., about 200 ppm or less), such as, e.g., streptomycin, erythromycin, and/or oxytetracycline. The presence of antibiotics in the culture can, in some embodiments, induce the microorganism to produce growth by-products that are active against, for example, bacterial pests. Additionally, in some embodiments, the pesticidal composition can comprise residual amounts of antibiotic substances, thus increasing the pesticidal capabilities of the composition.

For example, the microorganisms can be cultured in a medium comprising antibiotics such as, e.g., streptomycin, erythromycin, and/or oxytetracycline, at amounts of 0 to 200 ppm, preferably from 5 to 150 ppm, more preferably from 10 to 100 ppm.

The composition may further comprise other acceptable active or inactive components. In some embodiments, when, for example, the composition is used to supplement other antibiotic crop treatments, additives can be included to help enhance the pesticidal effects of treatment and decrease the amount of antibiotics required.

In some embodiments, the additives can include one or more salts, such as sodium chloride. The salt(s) can be added in concentrations of, for example, 0.1 to 20 g/L, or 1 to 15 g/L, or 5 to 10 g/L.

In some embodiments, the composition further comprises one or more solvents, such as ethanol, isopropyl alcohol, and/or propanol. The solvent(s) can be added in concentrations of, for example, 0.1 to 10 g/L, or 0.5 to 8 g/L, or 1 to 5 g/L.

In some embodiments, the additives can include additional purified biosurfactants, preferably, SLP at a concentration of, for example, 10 to 200 ppm, or 20-100 ppm.

In some embodiments, the additives can include one or more chelating agents. As used herein, “chelating agent” or “chelator” means an active agent capable of removing a metal ion from a system by, for example, forming a complex so that the metal ion cannot readily participate in or catalyze oxygen radical formation. Advantageously, the chelating agent can enhance the efficacy of an antimicrobial biosurfactant by modifying the cell walls of, for example, Gram-negative bacteria, to be more susceptible to surfactant treatment. Consequently, the ability to permeate Gram-negative bacteria broadens the spectrum of treatment capabilities for the subject invention.

Examples of chelating agents suitable for the present invention include, but are not limited to, dimercaptosuccinic acid (DMSA), 2,3-dimercaptopropanesulfonic acid (DMPS), alpha lipoic acid (ALA), thiamine tetrahydrofurfuryl disulfide (TTFD), penicillamine, ethylenediaminetetraacetic acid (EDTA), and citric acid. In preferred embodiments, the chelating agent is EDTA in concentration of 0.1 to 1.0% (v/v).

In one embodiment, the composition further comprises one or more adherent substances, which allow the composition to remain on the surfaces of plant vegetation for extended periods of time. Adherent substances can include charged polymers or polysaccharides, such as, for example, xanthan gum, guar gum, levan, xylinan, welan gum, gellan gum, curdlan, and/or pullulan.

In certain embodiments, commercial grade xanthan gum is used as the adherent. The concentration of the gum should be selected based on the content of the gum in the commercial product. If the xanthan gum is highly pure, then 0.001% (w/v−xanthan gum/solution) is sufficient.

In certain embodiments, the compositions of the subject invention have advantages over, for example, purified microbial metabolites alone. These advantages can include, for example, high concentrations of mannoprotein as a part of a yeast cell wall's outer surface, the presence of a variety of microbial growth by-products in the culture, such as biosurfactants, enzymes, solvents and/or other metabolites, and the presence of residual antibiotic substances in the culture.

### Growth of Microbes

The subject invention provides methods for cultivation of microorganisms and production of microbial metabolites and/or other by-products of microbial growth. In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The subject invention utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof. As used herein “fermentation” refers to cultivation or growth of cells under controlled conditions. The growth could be aerobic or anaerobic.

The methods can be performed in a batch process, a quasi-continuous process, or a continuous process.

The growth vessel used for growing microorganisms can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of microbes in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more. participate

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of the liquid, and air spargers for supplying bubbles of gas to the liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, isopropyl, propanol, butanol, pentanol, hexanol, isobutanol, and/or glycerol; fats and oils such as soybean oil, rice bran oil, canola oil, olive oil, corn oil, sesame oil, and/or linseed oil; etc. These carbon sources may be used independently or in a combination of two or more.

In one embodiment, the method comprises use of two carbon sources, one of which is a saturated oil selected from canola, vegetable, corn, coconut, olive, or any other oil suitable for use in, for example, cooking.

In one embodiment, the microorganisms can be grown on a solid or semi-solid substrate, such as, for example, corn, wheat, soybean, chickpeas, beans, oatmeal, pasta, rice, and/or flours or meals of any of these or other similar substances.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, calcium carbonate, sodium chloride and/or sodium carbonate. These inorganic salts may be used independently or in a combination of two or more.

In some embodiments, the method for cultivation may further comprise adding additional acids and/or antimicrobials in the liquid medium before, and/or during the cultivation process. Antimicrobial agents or antibiotics are used for protecting the culture against contamination, and can be present in the final product in low concentrations in order to aid in the treatment and/or prevention of bacterial infection in plants to which it is applied. For example, the microorganisms can be cultured in a medium comprising antibiotics such as, e.g., streptomycin, erythromycin, and/or oxytetracycline, at amounts of 0 to 200 ppm, preferably from 5 to 150 ppm, more preferably from 10 to 100 ppm.

Additionally, antifoaming agents may also be added to prevent the formation and/or accumulation of foam when gas is produced during cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the liquid medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention provides methods of producing a microbial growth by-product by cultivating a microbe strain of the subject invention under conditions appropriate for growth and production of the growth by-product. In one embodiment, the growth by-product is a biosurfactant, enzyme or other metabolite. The content of growth by-product in the medium produced by the method can be, for example, at least 20%, 30%, 40%, 50%, 60%, 70%, 80%, or 90%.

In the case of submerged fermentation, the biomass content of the fermentation broth may be, for example, from 5 g/l to 180 g/l or more. In one embodiment, the solids content of the broth is from 10 g/l to 150 g/l.

In the case of solid state fermentation or modified versions thereof, the cell concentration may be, for example, 1×10⁹, 1×10¹⁰, 1×10¹¹, 1×10¹² or 1×10¹³ cells or spores per gram of final product.

The microbial growth by-product produced by microorganisms of interest may be retained in the microorganisms or secreted into the growth medium. In another embodiment, the method for producing microbial growth by-product may further comprise steps of concentrating and purifying the microbial growth by-product of interest. In a further embodiment, the medium may contain compounds that stabilize the activity of microbial growth by-product.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells remains in the vessel as an inoculant for a new cultivation batch. The composition that is removed can be a microbe-free medium or contain cells, spores, mycelia, conidia or other microbial propagules. In this manner, a quasi-continuous system is created.

Advantageously, the methods of cultivation do not require complicated equipment or high energy consumption. The microorganisms of interest can be cultivated at small or large scale on site and utilized, even being still-mixed with their media. Similarly, the microbial metabolites can also be produced at large quantities at the site of need.

### Microbial Strains

The microorganisms that can be grown according to the subject methods can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In some embodiments, the microorganism is a fungus, including yeasts and molds. Examples of fungi suitable for use according to the current invention, include, but are not limited to, Acaulospora, Aspergillus, Aureobasidium (e.g., A. pullulans), Blakeslea, Candida (e.g., C. albicans, C. apicola), Debaryomyces (e.g., D. hansenii), Entomophthora, Fusarium, Hanseniaspora (e.g., H. uvarum), Hansenula, Issatchenkia, Kluyveromyces, Mortierella, Mucor (e.g., M. piriformis), Penicillium, Phythium, Phycomyces, Pichia (e.g., P. anomala, P. guielliermondii, P. occidentalis, P. kudriavzevii), Pseudozyma (e.g., P. aphidis), Rhizopus, Saccharomyces (S. cerevisiae, S. boulardii sequela, S. torula), Starmerella (e.g., S. bombicola), Torulopsis, Thraustochytrium, Trichoderma (e.g., T reesei, T. harzianum, T. virens), Ustilago (e.g., U. maydis), Wickerhamomyces (e.g., W. anomalus), Williopsis, Zygosaccharomyces (e.g., Z. bailii).

In one embodiment, the microorganism is a yeast characterized by its secretion of “killer toxins,” or toxic proteins or glycoproteins, to which the yeast itself is immune. These exotoxins are capable of killing other strains of yeast, fungi, or bacteria. Killer yeasts can include, but are not limited to, Wickerhamomyces, Pichia, Hansenula, Saccharomyces, Hanseniaspora, Ustilago Debaryomyces, Candida, Cryptococcus, Kluyveromyces, Torulopsis, Williopsis, Zygosaccharomyces and others.

In some embodiments, the microorganisms are bacteria, including Gram-positive and Gram-negative bacteria. Bacteria suitable for use according to the present invention include, for example, Acinetobacter (e.g., A. calcoaceticus, A. venetianus); Agrobacterium (e.g., A. radiobacter), Azotobacter (A. vinelandii, A. chroococcum), Azospirillum (e.g., A. brasiliensis), Bacillus (e.g., B. amyloliquefaciens, B. firmus, B. laterosporus, B. licheniformis, B. megaterium, B. mucilaginosus, B. subtilis, B. coagulans), Chlorobiaceae spp., Dyadobacter fermenters, Frankia spp., Frateuria (e.g., F. aurantia), Klebsiella spp., Microbacterium (e.g., M. laevaniformans), Pantoea (e.g., P. agglomerans), Pseudomonas (e.g., P. aeruginosa, P. chlororaphis, P. chlororaphis subsp. aureofaciens (Kluyver), P. putida), Rhizobium spp., Rhodospirillum (e.g., R. rubrum), Sphingomonas (e.g., S. paucimobilis), and/or Xanthomonas spp.

In certain embodiments, the subject invention utilizes a biochemical-producing microorganism that is tolerant to antibiotics. Antibiotic tolerance can be achieved by, for example, cultivating the microorganism in a medium comprising low concentrations (e.g., 200 ppm or less) of an antibiotic.

In preferred embodiments, the biochemical-producing microorganism produces biochemicals such as biosurfactants and/or enzymes with antibacterial, or otherwise pesticidal activity (e.g., against insects and/or nematodes).

In one embodiment, the beneficial microorganism is a yeast, such as, for example, Starmerella bombicola, Wickerhamomyces anomalus, Pseudozyma aphidis or Pichia spp. (e.g., P. guilliermondii (or Meyerozyma guilliermondii), P. kudriavzevii, or P. occidentalis).

In some embodiments, the beneficial microorganism is a non-plant-pathogenic bacteria, such as, for example, Bacillus amyloliquefaciens, Pseudomonas chlororaphis, or Rhodococcus erythropolis.

Other microbial strains can be used in accordance with the subject invention, including, for example, any other strains capable of producing biosurfactants and other enzymes and/or metabolites useful for treating bacterial pathogens in plants.

### Preparation of Microbe-Based Products

One microbe-based product of the subject invention is simply the fermentation medium containing the microorganism and/or the microbial growth by-products produced by the microorganism and/or any residual nutrients and/or antibiotics. The product of fermentation may be used directly without extraction or purification. If desired, extraction and purification can be easily achieved using standard extraction and/or purification methods or techniques described in the literature.

The microbe-based compositions may be used without further stabilization, preservation, and storage. Advantageously, direct usage of these microbe-based compositions preserves a high viability of the microorganisms, reduces the possibility of contamination from foreign agents and undesirable microorganisms, and maintains the activity of the by-products of microbial growth.

The microorganisms in the microbe-based products may be in an active or inactive form, or in the form of vegetative cells, reproductive spores, mycelia, conidia or any other form of microbial propagule. The microbe-based products may also contain a combination of any of these forms of a microorganism.

The microbe-based product may comprise medium in which the microbes were grown. The product may be, for example, at least, by weight, 1%, 5%, 10%, 25%, 50%, 75%, or 100% growth medium. The amount of biomass in the product, by weight, may be, for example, anywhere from 0% to 100% inclusive of all percentages therebetween.

The microbial growth by-products may be separated from the microorganisms and/or medium and used in a purified or unpurified form.

The microbes and/or fermentation products resulting from the microbial growth can be removed from the growth vessel and transferred via, for example, piping for immediate use.

In other embodiments, the composition can be placed in containers of appropriate size, taking into consideration, for example, the intended use, the contemplated method of application, the size of the fermentation tank, and any mode of transportation from microbe growth facility to the location of use. Thus, the containers into which the microbe-based composition is placed may be, for example, from 1 gallon to 1,000 gallons or more. In other embodiments the containers are 2 gallons, 5 gallons, 25 gallons, or larger.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

Upon harvesting the microbe-based composition from the growth vessels, further components can be added as the harvested product is placed into containers and/or piped (or otherwise transported for use). The additives can be, for example, buffers, carriers, other microbe-based compositions produced at the same or different facility, chelating agents, adherents, viscosity modifiers, preservatives, nutrients for selective beneficial microbe growth, tracking agents, solvents, biocides, antibiotics, surfactants (including purified or crude form biosurfactants), emulsifying agents, lubricants, solubility controlling agents, pH adjusting agents, stabilizers, ultra-violet light resistant agents and other ingredients specific for an intended use.

In certain embodiments, the microbe-based product comprises a carrier. The carrier may be any suitable carrier known in the art that permits the composition to be delivered to target plants and/or soil.

In one embodiment, the microbe-based product may comprise buffering agents including organic and amino acids or their salts. Suitable buffers include, for example, citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In one embodiment, the microbe-based product may comprise pH adjusting agents including, for example, potassium hydroxide, ammonium hydroxide, potassium carbonate or bicarbonate, hydrochloric acid, nitric acid, sulfuric acid or a mixture thereof.

In one embodiment, additional components such as an aqueous preparation of a salt as polyprotic acid such as sodium bicarbonate or carbonate, sodium sulfate, sodium phosphate, sodium chloride, sodium biphosphate, can be included in the formulation.

In one embodiment, prebiotics can be added to the microbe-based product to enhance beneficial microbial growth. Suitable prebiotics, include, for example, kelp extract, fulvic acid, fumaric acid, chitin (or chitin derivatives), humate and/or humic acid.

In an exemplary embodiment the microbe-based products further comprise one or more of: a salt (e.g., sodium chloride), a solvent (e.g., ethanol), a chelating agent (e.g., EDTA) and purified SLP, in addition to residual antibiotics from the cultivation medium.

In one embodiment, the microbe-based product is formulated for application to soil, seeds, whole plants, or plant parts (including, but not limited to, roots, tubers, stems, flowers and leaves). In preferred embodiments, the microbe-based product is formulated for application to above-ground biomass, such as fruit and leaves.

In certain embodiments, the microbe-based product is foimulated as, for example, liquid, liquid suspensions, emulsions, freeze or spray dried powders, granules, pellets, gels, dust, wettable powder, flowable powder, microcapsules, oils, or aerosols. In preferred embodiments, the composition is formulated as a liquid, a concentrated liquid, or as dry powder or granules that can be mixed with water and other components to form a liquid product. To improve or stabilize the effects of the composition, it can be blended with suitable adjuvants and then used as such or after dilution, if necessary.

In one embodiment, when the product is formulated as a dry granule or powder, glucose and glycerin can be added to serve as an osmoticum during storage and transport. In one embodiment, molasses can be included.

### Methods of Treating a Plant Bacterial Infection

In some embodiments, methods are provided for enhancing plant immunity, health, growth and/or yields by, for example, treating and/or preventing a bacterial infection in the plant, wherein a pesticidal composition of the subject invention is applied to the plant and/or its surrounding environment. In preferred embodiments, the plant is a citrus plant.

In some embodiments, the pesticidal composition comprises one or more microorganisms and/or their growth by/products. In some embodiments, the pesticidal composition does not comprise living microorganisms.

In some embodiments, the pesticidal composition does not comprise microorganisms at all, whether living or inactive. For example, in some embodiments, the pesticidal composition comprises microbial growth by-products, such as biosurfactants and/or enzymes, without microorganisms.

In one embodiment, the microbe-based product is cultivated with low concentrations of antibiotics. For example, streptomycin, erythromycin, and/or oxytetracycline, may be present in the culture medium at amounts of 0 to 200 ppm, from 5 to 150 ppm, or from 10 to 100 ppm. Thus, the microbe-based product may comprise residual concentrations of antibiotic substances when applied to a plant, crop, or environment.

As used herein, “applying” a composition or product refers to contacting a composition or product with a target or site such that the composition or product can have an effect on that target or site. The effect can be due to, for example, microbial growth and/or the action of a metabolite, enzyme, biosurfactant or other growth by-product.

Application can include contacting the microbe-based product directly with a plant, plant part, and/or the plant's surrounding environment (e.g., the soil). The microbe-product can be applied as a seed treatment (e.g., seed coating), to the surface of a plant (e.g., to the surface of the leaves, fruit, flowers, or roots), and/or to the soil surface. It can be, for example, sprayed, poured, spread, and/or broadcast over a plant, crop or field. It can also be, for example, tilled into soil, injected into soil, administered via soil drenching and/or administered through an irrigation system.

In one embodiment, the pesticidal composition is applied to the foliage and/or fruit of the plant.

In one embodiment, the composition can be efficiently applied via a center pivot irrigation system or with a spray over the seed furrow.

In one embodiment, the composition can be applied to soil surface without mechanical incorporation, where rainfall, sprinkler, flood, or drip irrigation activate the composition and allow the composition to percolate to plant roots.

Plants and/or their environments can be treated at any point during the process of cultivating the plant. For example, the microbe-based product can be applied to the soil prior to, concurrently with, or after the time when seeds are planted therein. It can also be applied at any point thereafter during the development and growth of the plant, including when the plant is flowering, fruiting, and during and/or after abscission of leaves.

In certain embodiments, the plant receiving treatment is healthy. In other method embodiments, the plant is affected by a plant disease or plant disease symptoms. The disease is preferably a bacterial disease.

Examples of bacterial infections affecting plants, against which the subject invention is useful, include, but are not limited to, Pseudomonas (e.g., P. savastanoi, Pseudomonas syringae pathovars); Ralstonia solanacearum; Agrobacterium (e.g., A. tumefaciens); Xanthomonas (e.g., X. oryzae pv. oryzae; X. campestris pathovars; X. axonopodis pathovars); Erwinia (e.g., E. amylovora); Xylella (e.g., X. fastidiosa); Dickeya (e.g., D. dadantii and D. solani); Pectobacterium (e.g., P. carotovorum and P. atrosepticum); Clavibacter (e.g., C. michiganensis and C. sepedonicus); Candidatus Liberibacter asiaticus; Pantoea; Ralstonia; Burkholderia; Acidovorax; Streptomyces; Spiroplasma; Phytoplasma; huanglongbing (HLB, citrus greening disease); citrus canker disease, citrus bacterial spot disease, citrus variegated chlorosis, citrus food and root rot, citrus and black spot disease.

In preferred embodiments, the methods are used to treat citrus greening disease (Candidatus Liberibacter asiaticus) and/or citrus canker disease (X. axonopodis).

In one embodiment, the method controls pathogenic bacteria themselves. In one embodiment, the method works by enhancing the immune health of plants to increase the ability to fight off infections.

In some embodiments, the methods are used to treat pests that act as vectors or carriers for bacterial pests. Thus, the subject methods can prevent the spread of plant pathogenic bacteria by controlling these carrier pests.

In certain plant diseases caused by plant pathogenic bacteria (especially in those that cause spots, cankers, blights, galls, or soft rots), the bacteria can form lesions in their host plants that produce droplets or masses of sticky exudates. The bacterial exudates are released through the lesions, e.g., cracks or wounds in the infected area, or through natural openings in the infected area of the plant. The bacteria can then be spread by, for example, wind, agricultural equipment, and/or disease vectors such as insects, e.g., flies, aphids, ants, beetles, whiteflies, bees, etc., and/or nematodes.

The bacteria can stick to the legs, bodies and mouthparts of these pests. The bacteria can also grow inside the digestive systems and in the hemolymph of pests. When the insects move to other parts of the plant or to other susceptible host plants, they carry the bacteria with them.

In a specific embodiment, the vector pest is a psyllid, such as Asian citrus psyllid or African citrus psyllid, both of which are known vectors for citrus greening disease. In some embodiments, the vector is at any stage of development in its life cycle, including larval and/or nymph stages.

In some embodiments, the subject invention is useful for treating vector pests due to its ability to suffocate the pests. For example, many insects respire through external openings in their bodies called spiracles. By penetrating, and in some cases blocking, these spiracles, the pesticidal compositions of the subject invention prevent the necessary gas exchange for the pest to survive.

In addition to treating and/or preventing bacterial infections, the present invention can be used to enhance health, growth and yields of plants and/or crops in, for example, agriculture, horticulture, greenhouses, landscaping, and the like.

In certain embodiments, the methods and compositions according to the subject invention reduce damage to a plant caused by pests, compared to an untreated plant, by up to 1%, 5%, 10%, 20%, 30%, 40%, 50%, 60% 70%, 80%, or 90% or more.

In one embodiment, the methods and compositions according to the subject invention increase crop yield by at least 5%, 10%, 20%, 30%, 40%, 50%, 60% 70%, 80%, or 90% or more compared to an untreated crop.

In another embodiment, the methods and compositions according to the subject invention can increase plant biomass by at least 5%, 10%, 20%, 30%, 40%, 50%, 60% 70%, 80%, or 90% or more compared to an untreated plant.

The microbe-based product may also be applied so as to promote colonization of the roots and/or rhizosphere as well as the vascular system of the plant in order to promote plant health and vitality. Thus, nutrient-fixing microbes such as rhizobium and/or mycorrhizae can be promoted as well as other endogenous (already present in the soil), as well as exogenous, microbes, or their by-products that promote crop growth, health and/or yield. The microbe-based product can also support a plant's vascular system by, for example, entering and colonizing said vascular system and contributing metabolites, and nutrients important to plant health and productivity.

In one embodiment, the method can be used for enhancing penetration of beneficial molecules through the outer layers of plant cells, e.g., root cells.

The present invention can also be used for improving one or more qualities of soil, thereby enhancing the performance of the soils for agricultural, home and gardening purposes.

The subject invention can be used to improve any number of qualities in any type of soil, for example, clay, sandy, silty, peaty, chalky, loam soil, and/or combinations thereof. Furthermore, the methods and compositions can be used for improving the quality of dry, waterlogged, porous, depleted, compacted soils and/or combinations thereof.

In one embodiment, the method can be used for improving the drainage and/or dispersal of water in waterlogged soils. In one embodiment, the method can be used for improving water retention in dry soil.

In one embodiment, the method can be used for improving nutrient retention in porous and/or depleted soils.

In certain embodiments, the composition can be used to enhance the effectiveness of other compounds by, for example, enhancing the penetration of a drug compound (e.g., an antibiotic) into a plant or pest.

The microbe-based products can also be used to supplement other treatments, for example, antibiotic treatments. Advantageously, the subject invention helps reduce the amount of antibiotics that must be administered to a crop or plant in order to be effective at treating and/or preventing bacterial infection.

According to the subject methods, the pesticidal composition can be applied either alone or in combination with other compounds for controlling pests and/or for efficiently enhancing plant immunity, health and growth. For example, in some embodiments, the composition further comprises, and/or is applied alongside, commercial and/or natural herbicides, fertilizers, pesticides, antibiotics and/or soil amendments.

In some embodiments, the treatment is enhanced with one or more of: an adherent substance, such as xanthan gum, a salt, such as sodium chloride, a solvent, such as ethanol, a purified biosurfactant, such as SLP, and/or a chelating agent, such as EDTA

In one embodiment, the composition can be mixed and/or applied with a commercial fertilizer, such as Scott's Miracle-Gro®, or another source of nutrients (e.g., nitrogen-phosphorous-potassium (NPK) macronutrients). Other additional components that can be included are macronutrients and/or micronutrients, such as magnesium, phosphate, nitrogen, potassium, selenium, calcium, sulfur, iron, copper, and zinc, and/or prebiotics, such as kelp extract, fulvic acid, fumaric acid, chitin (or chitin derivatives), humate, and/or humic acid. The exact materials and the quantities thereof can be customized to a particular crop or plant based on the needs thereof, and can be determined by a grower or an agricultural scientist.

The composition can also be used in combination with other crop management systems. In one embodiment, the composition can optionally comprise, or be applied with, natural and/or chemical pesticides and/or repellants, such as, for example, azoxystrobin, ipconazole, metalaxyl, trifloxystrobin, clothiandin, VOTiVO, thiamethoxam, cyantaniliprole, fludioxonil, tioxazafen, glycolipids, lipopeptides, deet, diatomaceous earth, citronella, essential oils, mineral oils, garlic extract, chili extract, and/or any known commercial and/or homemade pesticide that is compatible with the combination of microorganisms being applied.

The methods can further comprise adding materials to enhance beneficial microbe growth and/or plant growth during application (e.g., adding prebiotics or other nutrients). Other additional materials can include, for example, nutrients such as magnesium, phosphate, nitrogen, potassium, selenium, calcium, sulfur, iron, copper, and zinc. The exact materials and the quantities thereof can be determined by one skilled in the art of cultivating plants.

### Target Plants

The subject invention can be useful in the prevention and/or treatment of bacterial infections that cause diseases in plants.

As used here, the term “plant” includes, but is not limited to, any species of woody, ornamental or decorative, crop or cereal, fruit or vegetable, fruit plant or vegetable plant, flower or tree, macroalga or microalga, phytoplankton and photosynthetic algae (e.g., green algae Chlamydomonas reinhardtii). It also refers to a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a stem, a leaf, a flower petal, etc.

Furthermore, the plant can be standing alone, for example, in a garden, or it can be one of many plants, for example, as part of an orchard or farm crop.

The term “plant tissue” includes differentiated and undifferentiated tissues of plants including those present in roots, shoots, leaves, pollen, seeds and tumors, as well as cells in culture (e.g., single cells, protoplasts, embryos, callus, etc.). Plant tissue may be in planta, in organ culture, tissue culture, or cell culture. The term “plant part” as used herein refers to a plant structure or a plant tissue.

In some embodiments, the plants are crop plants. As used herein, “crop plants” refer to any species of plant or alga edible by humans or used as a feed for animals or fish or marine animals, or consumed by humans, or used by humans (e.g., natural pesticides), or viewed by humans (e.g., flowers, trees) or any plant or alga, or a part thereof, used in industry or commerce or education.

In specific preferred embodiments, the plant is a citrus plant. Examples of citrus plants according to the subject invention include, but are not limited to, orange trees; lemon trees, lime trees and/or grapefruit trees. Other examples include Citrus maxima (Pomelo), Citrus medica (Citron), Citrus micrantha (Papeda), Citrus reticulata (Mandarin orange), Citrus paradisi (grapefruit), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera), Citrus indica (Indian wild orange), Citrus macroptera, and Citrus latipes, Citrus x aurantiifolia (Key lime), Citrus x aurantium (Bitter orange), Citrus x latifolia (Persian lime), Citrusx limon (Lemon), Citrus x limonia (Rangpur), Citrus x sinensis (Sweet orange), Citrus x tangerina (Tangerine), Imperial lemon, tangelo, orangelo, tangor, kinnow, kiyomi, Minneola tangelo, oroblanco, ugli, Buddha's hand, citron, bergamot orange, blood orange, calamondin, clementine, Meyer lemon, and yuzu. In some embodiments, the plant is a relative of a citrus plant, such as orange jasmine, limeberry, and trifoliate orange (Citrus trifolata).

Other examples of plants for which the invention is useful include, but are not limited to, cereals and grasses (e.g., wheat, barley, rye, oats, rice, maize, sorghum, corn), beets (e.g., sugar or fodder beets); leguminous crops (e.g., beans, lentils, peas or soya); oil crops (e.g., oilseed rape, mustard, poppies, olives, sunflowers, coconut, castor, cocoa or nuts); cucurbits (e.g., pumpkins, cucumbers, squash or melons); fiber plants (e.g., cotton, flax, hemp or jute); Lauraceae (e.g., avocado, Cinnamonium or camphor); and also almond, apple, asparagus, berries, banana, cabbage, cacao, carrot, cassava, cherry, chili, citrus, coconut, coffee, corn, cotton, eggplant, grape, hops, legume, lettuce, mango, olive, onion, palm, pear, peach, plum, peanut, pepper, potato, rapeseed, rice, rubber, soybean, strawberry, sugar cane, sunflower, sweet potato, tea, tobacco, tomato, walnut, yam, pomaceous fruit, stone fruit, soft fruit, herbs, spices, spinach, medicinal plants, the plantain family, latex plants, cut flowers and ornamentals, and any relatives thereof.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product, when desired. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used (e.g., a citrus grove), for example, within 300 miles, 200 miles, or even within 100 miles. Advantageously, this allows for the compositions to be tailored for use at a specified location. The formula and potency of microbe-based compositions can be customized for specific local conditions at the time of application, such as, for example, which soil type, plant and/or crop is being treated; what season, climate and/or time of year it is when a composition is being applied; and what mode and/or rate of application is being utilized.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products to improve plant health, root growth and productivity.

The cultivation time for the individual vessels may be, for example, from 1 to 7 days or longer. The cultivation product can be harvested in any of a number of different ways. Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Preparation of Sophorolipids

A natural mixture of sophorolipids was synthesized by fermentation of S. bombicola in a fermentation medium containing 10 to 100 ppm of streptomycin, erythromycin, and/or oxytetracycline, 100 g/L glucose, 10 g/L yeast extract, 1 g/L urea and 100 ml/L canola oil in water. Up to 200 ppm of SLP can also be used to supplement the culture.

The yeast and culture medium were incubated at pH 3.0-3.5 under aerobic conditions and for a period of time sufficient for initial accumulation of biomass (typically about 24 hours to about 48 hours). The temperature was held at 22° to 28° C. and dissolved oxygen concertation was held within 15% to 30% (of 100% ambient air). Once initial biomass accumulation was achieved, pH was adjusted to 5.5 and the process continued.

When the culture acidified to pH 3.5, the fermentation process continued, keeping the pH stable at this level until sufficient accumulation of SLP was achieved in the medium. After 72 hours of fermentation, sophorolipids precipitated as a brown viscous layer at the bottom of the fermentation vessel.

The SLPs were then subsequently recovered from the fermentation medium to be used with or without the cell biomass (depending on the areas and types of application). The sophorolipid layer was diluted to a SLP concentration of 0.05 to 0.5 g/L for use in producing microbe-based products. Advantageously, the sophorolipid broth also contains some residual yeast cells and trace amounts of metabolites and media components.

### Example 2—Preparation of MEL Treatment Product

The subject systems can be used to produce mannosylerythritol lipids (MELs) on an industrial scale and without contamination of the production culture.

A seed culture of Pseudozyma aphidis was produced at a pH of 6.2. The medium for cultivating the seed culture was comprised of (g/L):
Glucose, 50 g
NH₄NO₃, 1 g
KH₂PO₄, 0.5 g
K₂HPO₄, 0.5 g
MgSO₄, 0.2 g
Yeast Extract, 1 g
   The seed culture was rotated at 100 rpm for two days at 30° C. It was then used as an inoculant for producing MEL in the single-tank reactor.

The medium for MEL production at pH 6.2 comprised (g/L or mL/L):
NaNO₃, 2 g
KH₂P4₃, 0.2 g
MgSO₄, 0.2 g
Yeast Extract, 1 g
H₂O, 920 mL
Canola Oil, 80 mL (autoclaved separately).

The media volume was adjusted to the desired volume, minus the volume of canola oil. The medium can also be supplemented with 10 to 100 ppm of streptomycin, erythromycin, and/or oxytetracycline, or up to 200 ppm pure sophorolipid.

The yeast and culture medium were incubated under aerobic conditions and for a period of time sufficient for initial accumulation of biomass (typically about 24 hours to about 48 hours).

The temperature of cultivation was 27-30° C., with agitation rate of 300-500 rpm, DO at 5-30% (or from 15 to 20%), and air circulation at 1V/Vm.

After two days of fermentation, 40 g/L erythritol in H₂O was added. The fermentation process continued, keeping the pH stable until sufficient accumulation of MELs was achieved in the medium. Total fermentation time was 15 days.

Total MEL concentration that can be produced ranges from 50 to 100 g/L. The temperature can then be increased to 70-90° C. if inactivation of the yeast cells is desired. The oily layer (MELs) is then collected and can be prepared as a microbe-based product for a variety of uses, including the methods of the subject invention.

1. A composition for treating and/or preventing a bacterial plant pathogen, the composition comprising
one or more beneficial microorganisms and/or microbial growth by-products,
one or more adherent substances, and
at least one antibiotic at a concentratin of about 200 ppm or less.

2. The composition of claim 1, further comprising sodium chloride, ethanol and/or a purified biosurfactant.

3. The composition of claim 2, wherein the purified biosurfactant is a sophorolipid (SLP).

4. The composition of claim 1, comprising an antibiotic selected from streptomycin, erythromycin, and oxytetracycline.

5. The composition of claim 1, wherein the beneficial microorganisms are yeasts, fungi and/or bacteria.

6. The composition of claim 1, wherein the beneficial microorganisms are cultivated in a medium comprising the of antibiotic.

7. The composition of claim 1, wherein the beneficial microorganisms are selected from Starmerella bombicola, Wickerhamomyces anomalus, Pseudozyma aphidis, Meyerozyma guilliermondii, Pichia occidentalis, and Pichia kudriavzevii.

8. The composition of claim 1, wherein the beneficial microorganism are non-plant-pathogenic bacteria selected from Bacillus amyloliquefaciens, Pseudomonas chlororaphis, and Rhodococcus erythropolis.

9. The composition of claim 1, wherein the microbial growth by-products are biosurfactants and/or enzymes.

10. The composition of claim 9, wherein the biosurfactants are glycolipids and/or lipopeptides.

11. The composition of claim 9, wherein the biosurfactants are selected from sophorolipids (SLP), trehalose lipids, mannosylerythritol lipids (MEL), surfactin, lichenysin and athrofactin.

12. The composition of claim 9, wherein the enzymes are chitinase and/or beta-glucanase.

13. The composition of claim 1, comprising no living microorganisms.

14. The composition of claim 1, comprising no living or inactive microorganisms.

15. The composition of claim 1, wherein the adherent substance is xanthan gum and/or guar gum.

16. A method for enhancing plant immunity, health, growth and/or yields, wherein a composition of claim 1 is applied to the plant and/or its surrounding environment.

17. The method of claim 16, wherein the plant is a citrus plant.

18. The method of claim 16, used to treat and/or prevent a bacterial infection in the plant.

19. The method of claim 18, used to treat and/or prevent citrus greening disease and/or citrus canker disease.

20. The method of claim 16, used to control a pest that can act as a vector or carrier for a plant bacterial pathogen.

21. The method of claim 20, wherein the pest is Asian citrus psyllid or African citrus psyllid.
